(19) United States
(12) Patent Application Publication
(10) Pub. No.: US 2018/0149010 A1
(43) Pub. Date: May 31, 2018

(54) Well Construction Communication and Control

(71) Applicant: Schlumberger Technology Corporation, Sugar Land, TX (US)

(72) Inventors: Shunfeng Zheng, Katy, TX (US); Guillaume Tamboise, Katy, TX (US); Joergen K. Johnsen, Katy, TX (US); Juan Jose Rojas, Katy, TX (US)

(21) Appl. No.: 15/361,759

(22) Filed: Nov. 28, 2016

(51) Int. Cl. E21B 44/00; H04L 12/46; H04L 29/12; G05B 19/04

(52) U.S. Cl. CPC E21B 44/00; H04L 12/4641; H04L 2012/6454; G05B 19/041; H04L 61/106

(57) ABSTRACT

Methods and apparatus for use in well construction, including a communications network having processing systems and a common data bus. At least one processing system implements subsystem virtual networks in the communications network. Each subsystem virtual network communicatively couples together equipment controllers of equipment of a respective control subsystem. At least one processing system implements a configuration manager that translates communications from the subsystem virtual networks to a common protocol, and makes data of the communications accessible through the common data bus. At least some equipment controllers access data from the common data bus through respective subsystem virtual networks. At least one processing system implements a process application that accesses data from the common data bus. At least one processing system implements a human-machine interface that accesses data from the common data bus. At least one processing system implements a coordinated controller that issues command to the equipment controllers.

### BACKGROUND OF THE DISCLOSURE

In the drilling of oil and gas wells, drilling rigs are used to create a well by drilling a wellbore into a formation to reach oil and gas deposits (e.g., hydrocarbon deposits). During the drilling process, as the depth of the wellbore increases, so does the length and weight of the drillstring. A drillstring may include sections of drill pipe, a bottom hole assembly, and other tools for creating a well. The length of the drillstring may be increased by adding additional sections of drill pipe as the depth of the wellbore increases. Various components of a drilling rig can be used to advance the drillstring into the formation.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces an apparatus that includes a communications network having one or more processing systems and a common data bus. Each processing system includes a processor and a memory including computer program code. At least one of the processing systems implements subsystem virtual networks in the communications network. Each subsystem virtual network communicatively couples together equipment controllers of equipment of a respective control subsystem of a well construction system. At least one of the processing systems implements a configuration manager that translates communications from the subsystem virtual networks to a common protocol, and makes data of the communications accessible through the common data bus. At least some of the equipment controllers access data from the common data bus through respective subsystem virtual networks. At least one of the processing systems implements a process application that accesses data from the common data bus. At least one of the processing systems implements a human-machine interface that accesses data from the common data bus. At least one of the processing systems implements a coordinated controller that issues command to the equipment controllers.

The present disclosure also introduces an apparatus that includes a drilling system and a communications network. The drilling system includes a first control subsystem useable in making a wellbore in a formation. The first control subsystem includes one or more first equipment controllers (ECs) operable to control a first operation of the first control subsystem, to receive a signal of a first sensor of the first control subsystem, or a combination thereof. The communications network includes one or more processing systems and a common data bus. Each processing system comprises a processor and a memory including computer program code. At least one of the processing systems is configured to implement a first subsystem virtual network in the communications network. The first subsystem virtual network is communicatively coupled to the one or more first ECs. At least one of the processing systems is operable to implement a configuration manager that is operable to translate communications from the first subsystem virtual network to a common protocol and to make data of the communications accessible through the common data bus. At least one of the processing systems is operable to implement a process application that is operable to access data from the common data bus. At least one of the processing systems is operable to implement a human-machine interface that is operable to access data from the common data bus. At least one of the processing systems is operable to implement a coordinated controller that is operable to issue a command to at least one of the one or more first ECs.

The present disclosure also introduces a method including operating a communications network having one or more processing systems and a common data bus. Operating the communications network includes implementing subsystem virtual networks using at least one of the processing systems. Via each of the subsystem virtual networks, equipment controllers of equipment a respective control subsystem of a drilling system are coupled together. Operating the communications network also includes operating a configuration manager using at least one of the processing systems. Operating the configuration manager includes translating communications from the subsystem virtual networks to a common protocol, and providing data of the translated communications to the common data bus, the data including sensor data, status data, of a combination thereof. Operating the communications network also includes operating a process application using at least one of the processing systems. Operating the process application includes accessing data from the common data bus. Operating the communications network also includes operating a human-machine interface using at least one of the processing systems. Operating the human-machine interface includes accessing data from the common data bus. Operating the communications network also includes operating a coordinated controller using at least one of the processing systems. Operating the coordinated controller includes issuing a command to at least one of the equipment controllers of the control subsystems.

The present disclosure also introduces a method including operating a first drilling subsystem comprising controlling a first component of the first drilling subsystem with a first equipment controller (EC). The method also includes implementing a first virtual network communicatively coupled to the first EC, and operating a configuration manager on one or more processing systems. Operating the configuration manager includes translating first communications from the first virtual network to a common protocol, and providing data of the translated first communications to a common data bus, the data including sensor data, status data, of a combination thereof. The method also includes operating a process application on one or more processing systems. Operating the process application includes accessing data from the common data bus. The method also includes operating a human-machine interface on one or more processing systems. Operating the human-machine interface includes accessing data from the common data bus. The method also includes operating a coordinated controller on one or more processing systems. Operating the coordinated controller includes issuing a command to the first EC to alter an operation of the first component.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of at least a portion of an example implementation of apparatus according to one or more aspects of the present disclosure.

FIG. 3 is a schematic view of at least a portion of an example implementation of apparatus according to one or more aspects of the present disclosure.

FIG. 4 is a schematic view of at least a portion of an example implementation of apparatus according to one or more aspects of the present disclosure.

FIG. 5 is a schematic view of at least a portion of an example implementation of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed.

Systems and methods and/or processes according to one or more aspects of the present disclosure may be used or performed in connection with well construction at a well site, such as construction of a wellbore to obtain hydrocarbons (e.g., oil and/or gas) from a formation, including drilling the wellbore. For example, some aspects may be described in the context of drilling a wellbore in the oil and gas industry. One or more aspects of the present disclosure may be used in other systems. Various subsystems used in constructing the well site may have sensors and/or controllable components that are communicatively coupled to one or more equipment controllers (ECs). An EC can include a programmable logic controller (PLC), an industrial computer, a personal computer based controller, a soft PLC, the like, and/or any example controller configured and operable to perform sensing of an environmental status and/or control equipment. Sensors and various other components may transmit sensor data and/or status data to an EC, and controllable components may receive commands from an EC to control operations of the controllable components. One or more aspects disclosed herein may allow communication between ECs of different subsystems through virtual networks. Sensor data and/or status data may be communicated through virtual networks and a common data bus between ECs of different subsystems. Additionally, a coordinated controller can implement control logic to issue commands to various ones of the ECs through the virtual networks and common data bus to thereby control operations of one or more controllable components. Additional details of some example implementations are described below. A person having ordinary skill in the art will readily understand that one or more aspects of systems and methods and/or processes disclosed herein may be used in other contexts, including other systems.

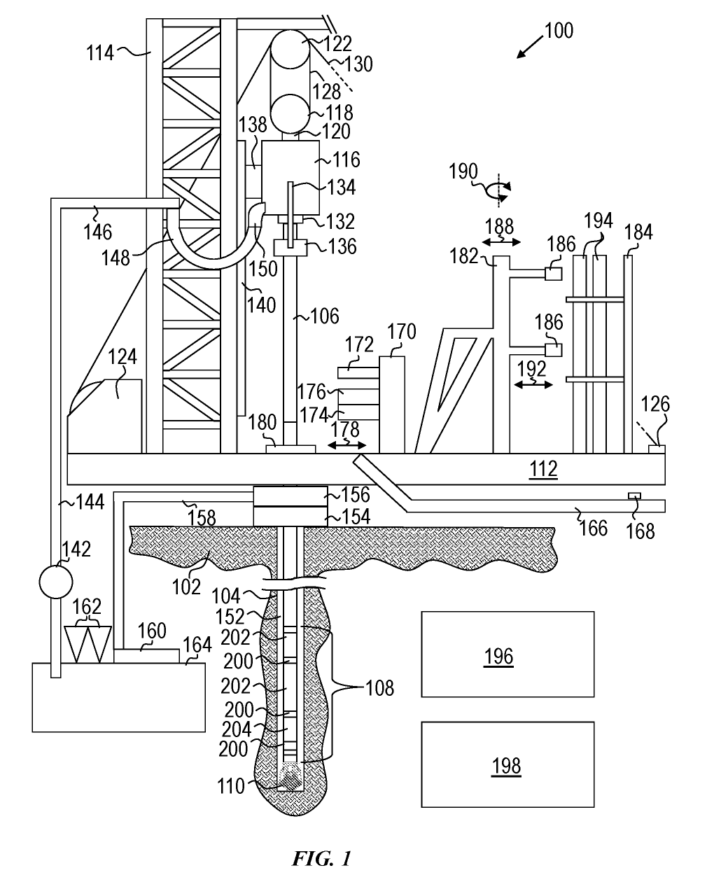

FIG. 1 is a schematic view of at least a portion of an example implementation of a drilling system 100 operable to drill a wellbore 104 into one or more subsurface formations 102 at a well site in accordance with one or more aspects of the present disclosure. A drillstring 106 penetrates the wellbore 104 and includes a bottom hole assembly (BHA) 108 that comprises or is mechanically coupled to a drill bit 110. The drilling system 100 includes a mast 114 (at least a portion of which is depicted in FIG. 1) extending from a rig floor 112 that is over the wellbore 104. A top drive 116 is suspended from the mast 114 and is mechanically coupled to the drillstring 106. The top drive 116 provides a rotational force (e.g., torque) to drive rotational movement of the drillstring 106, which may advance the drillstring 106 into the formation and form the wellbore 104.

The top drive 116 is suspended from the mast 114 using hoisting equipment. The hoisting equipment includes a traveling block 118 with a hook 120, a crown block 122, a drawworks 124, a deadline anchor 126, a supply reel (not depicted), and a drill line 128 with a deadline 130 (a portion of which is shown in phantom). The hook 120 of the traveling block 118 mechanically couples the top drive 116. The crown block 122 is suspended from and supported by the mast 114. The drawworks 124 and the deadline anchor 126 are on and supported by the rig floor 112. The drill line 128 is supplied from the supply reel through the deadline anchor 126. The drill line 128 may be wrapped around and clamped at the deadline anchor 126 such that the drill line 128 that extends from the deadline anchor 126 to the crown block 122 is stationary during normal drilling operations, and hence, the portion of the drill line 128 that extends from the deadline anchor 126 to the crown block 122 is referred to as the deadline 130. The crown block 122 and traveling block 118 comprise one or more pulleys or sheaves. The drill line 128 is reeved around the pulleys or sheaves of the crown block 122 and the traveling block 118. The drill line 128 extends from the crown block 122 to the drawworks 124. The drawworks 124 can comprise a drum, a prime mover (e.g., an engine or motor), a control system, and one or more brakes, such as a mechanical brake (e.g., a disk brake), an electrodynamic brake, and/or the like. The prime mover of the drawworks 124 drives the drum to rotate and reel in drill line 128, which in turn causes the traveling block 118 and top drive 116 to move upward. The drawworks 124 can release drill line 128 by a controlled rotation of the drum using the prime mover and control system, and/or by disengaging the prime mover (such as with a clutch) and disengaging and/or operating one or more brakes to control the release of the drill line 128. By releasing drill line 128 from the drawworks 124, the traveling block 118 and top drive 116 may move downward. In some examples where the drilling system is an off-shore system, the hoisting equipment may also include a motion or heave compensator between the mast 114 and the crown block 122 and/or between the traveling block 118 and the hook 120, for example.

The top drive 116 is suspended by the hook 120 and includes a prime mover (not specifically depicted) with a drive shaft 132, a grabber (not specifically depicted), a swivel (not specifically depicted), and a pipe handling assembly 134 with an elevator 136. The drillstring 106 is mechanically coupled to the drive shaft 132 (e.g., with or without a sub saver between the drillstring 106 and the drive shaft 132). The prime mover drives the drive shaft 132, such as through a gear box or transmission, to rotate the drive shaft 132 and, therefore, the drillstring 106, which, when working in conjunction with operation of the drawworks 124, can advance the drillstring 106 into the formation and form the wellbore 104. The pipe handling assembly 134 and elevator 136 allow the top drive 116 to handle tubulars, e.g., pipes, that are not mechanically coupled to the drive shaft 132, for example. As examples, when the drillstring 106 is being tripped into or out of the wellbore 104, the elevator 136 can grasp onto the tubulars of the drillstring 106 such that the tubulars may be raised and/or lowered using the hoisting equipment mechanically coupled to the top drive 116. The grabber includes a clamp that clamps onto a tubular when making up and/or breaking out a connection of a tubular with the drive shaft 132. The top drive 116 has a guide system 138, such as rollers, that track up and down a guide rail 140 on the mast 114. The guide system 138 and guide rail 140 can aid in keeping the top drive 116 aligned with the wellbore 104 and in preventing the top drive 116 from rotating during drilling by transferring the reactive torque from the drillstring 106 to the mast 114.

A drilling fluid circulation system circulates drilling fluid (e.g., mud) to the drill bit 110. A pump 142 delivers drilling fluid through a discharge line 144, stand pipe 146, rotary hose 148, and a gooseneck 150 to the swivel of the top drive 116. The swivel conducts the drilling fluid through the tubulars of the drillstring 106, and the drilling fluid exits the drillstring 106 via ports in the drill bit 110. The drilling fluid then circulates upward through the annulus 152 defined between the outside of the drillstring 106 and the wall of the wellbore 104. In this manner, the drilling fluid lubricates the drill bit 110 and carries formation cuttings up to the surface as the drilling fluid is circulated. At the surface, the drilling fluid flows through a blowout preventer 154 and a bell nipple 156 that diverts the drilling fluid to a return flowline 158. The return flowline 158 directs the drilling fluid to a shale shaker 160 that removes large formation cuttings from the drilling fluid. The drilling fluid is then directed to reconditioning equipment 162. Reconditioning equipment 162 can remove gas and/or finer formation cuttings from the drilling fluid. The reconditioning equipment 162 can include a desilter, a desander, a degasser, and/or the like. After being treated by the reconditioning equipment 162 and/or between being treated by various ones of the reconditioning equipment 162, the drilling fluid is conveyed to one or more mud tanks 164. In some examples, intermediate mud tanks can be used to hold drilling fluid between the shale shaker 160 and various ones of the reconditioning equipment 162. The mud tank(s) 164 can include an agitator to maintain uniformity of the drilling fluid contained in the mud tank 164. The pump 142 then pumps for recirculation drilling fluid from the mud tank(s) 164. A hopper (not depicted) may be disposed in a flowline between the mud tank(s) 164 and the pump 142 to disperse an additive, such as caustic soda, in the drilling fluid.

A catwalk 166 can be used to convey tubulars from a ground level to the rig floor 112. The catwalk 166 has a horizontal portion and an inclined portion that extends between the horizontal portion and the rig floor 112. A skate 168 is positioned in a groove in the horizontal and inclined portions of the catwalk 166. The skate 168 can be driven along the groove by a rope and pulley system, for example. Additionally, one or more racks can adjoin the horizontal portion of the catwalk 166, and the racks can have a spinner unit for transferring tubulars to the groove in the horizontal portion of the catwalk 166.

An iron roughneck 170 is on the rig floor 112. The iron roughneck 170 comprises a spinning system 172 and a torque wrench comprising a lower tong 174 and an upper tong 176. The iron roughneck 170 is moveable (e.g., in a translation movement 178) to approach the drillstring 106 (e.g., for making up and/or breaking out a connection of the drillstring 106) and to move clear of the drillstring 106. The spinning system 172 is generally used to apply low torque spinning to make up and/or break out a threaded connection between tubulars of the drillstring 106. The torque wrench applies a higher torque to make up and/or break out the threaded connection.

A reciprocating slip 180 is on and/or in the rig floor 112. The drillstring 106 extends through the reciprocating slip 180. The reciprocating slip 180 can be in an open position to allow advancement of the drillstring 106 through the reciprocating slip 180, and the reciprocating slip 180 can be in a closed position to clamp the drillstring 106 to prevent advancement of the drillstring 106. In a closed position, the reciprocating slip 180 may suspend the drillstring 106 in the wellbore 104.

In operation, the hoisting equipment lowers the drillstring 106 while the top drive 116 rotates the drillstring 106 to advance the drillstring 106 downward in the wellbore 104. During the advancement of the drillstring 106, the reciprocating slip 180 is in an open position, and the iron roughneck 170 is clear of the drillstring 106. When the upper portion of the tubular in the drillstring 106 that is made up to the top drive 116 is near to the reciprocating slip 180 and/or rig floor 112, the top drive 116 ceases rotating the drillstring 106, and the reciprocating slip 180 closes to clamp the drillstring 106. The grabber of the top drive 116 clamps the upper portion of the tubular made up to the drive shaft 132. Once clamped, the drive shaft 132 is driven by the prime mover of the top drive 116 and transmission or gearbox in a direction reverse from the drilling rotation to break out the connection between the drive shaft 132 and the drillstring 106. The grabber of the top drive 116 then releases the tubular of the drillstring 106.

Multiple tubulars may be loaded on the racks of the catwalk 166. Individual tubulars can be transferred from a rack to the groove in the catwalk 166, such as by the spinner unit. The tubular in the groove can be conveyed along the groove by the skate 168 as driven, e.g., by a rope and pulley system. As the tubular is conveyed (e.g., pushed) along the groove by the skate 168, an end of the tubular reaches the inclined portion of the catwalk 166 and is conveyed along the incline to the rig floor 112. After the tubular is sufficiently conveyed, the end of the tubular projects above the rig floor 112, and the elevator 136 is able to grasp around the tubular.

With the connection between the drillstring 106 and the drive shaft 132 broken out and with the elevator 136 grasping a tubular, the hoisting equipment raises the elevator 136, e.g., the drawworks 124 reels in the drill line 128 to raise the traveling block 118, and hence, the top drive 116 and the elevator 136 with the tubular. The tubular suspended by the elevator 136 is aligned with the upper portion of the drillstring 106. The iron roughneck 170 is moved 178 toward the drillstring 106, and the lower tong 174 clamps onto the upper portion of the drillstring 106. The spinning system 172 then rotates the suspended tubular (e.g., a threaded male connector) into the upper portion of the drillstring 106 (e.g., a threaded female connector). Once the spinning system 172 has provided the low torque rotation to make up the connection between the suspended tubular and the upper portion of the drillstring 106, the upper tong 176 clamps onto the suspended tubular and rotates the suspended tubular with a high torque to complete making up the connection between the suspended tubular and the drillstring 106. In this manner, the suspended tubular becomes a part of the drillstring 106. The iron roughneck 170 then releases the drillstring 106 and is moved 178 clear of the drillstring 106.

The grabber of the top drive 116 then clamps onto the drillstring 106. The drive shaft 132 (e.g., a threaded male connector) is brought into contact with the drillstring 106 (e.g., a threaded female connector) and is rotated by the prime mover to make up a connection between the drillstring 106 and the drive shaft 132. The grabber then releases the drillstring 106, and the reciprocating slip 180 is moved into the open position. Drilling may then resume.

A pipe handling manipulator (PHM) 182 and a fingerboard 184 are illustrated on the rig floor 112, although in other examples, one or both of the PHM 182 and a fingerboard 184 can be off of the rig floor 112. The fingerboard 184 provides storage (e.g., temporary storage) of tubulars 194 during various operations, such as during and between tripping out and tripping in the drillstring 106. The PHM 182 is capable of transferring tubulars between the drillstring 106 and the fingerboard 184. The PHM 182 includes arms and clamps 186. The clamps 186 are capable of grasping and clamping onto a tubular while the PHM 182 transfers the tubular. The PHM 182 is movable in one or more translation direction 188 and/or a rotational direction 190 around an axis of the PHM 182. The arms of the PHM 182 can extend and retract along direction 192.

To trip out the drillstring 106, the hoisting equipment raises the top drive 116, and the reciprocating slip 180 closes to clamp the drillstring 106. The elevator 136 closes around the drillstring 106. The grabber of the top drive 116 clamps the upper portion of the tubular made up to the drive shaft 132. Once clamped, the drive shaft 132 is driven by the prime mover and transmission or gearbox of the top drive 116 in a direction reverse from the drilling rotation to break out the connection between the drive shaft 132 and the drillstring 106. The grabber of the top drive 116 then releases the tubular of the drillstring 106, and the drillstring 106 can be suspended, at least in part, by the elevator 136. The iron roughneck 170 is moved 178 toward the drillstring 106. The lower tong 174 clamps onto a lower tubular at a connection of the drillstring 106, and the upper tong 176 clamps onto an upper tubular at the connection of the drillstring 106. The upper tong 176 then rotates the upper tubular to provide a high torque to break out the connection between the upper and lower tubulars. Once the high torque has been provided, the spinning system 172 rotates the upper tubular to break out the connection, and the upper tubular is suspended above the rig floor 112 by the elevator 136. The iron roughneck 170 then releases the drillstring 106 and is moved 178 clear of the drillstring 106.

The PHM 182 then moves (e.g., with movement along directions 188, 190, and/or 192) to grasp with the clamps 186 the tubular suspended from the elevator 136. Once the clamps 186 have grasped the suspended tubular, the elevator 136 opens to release the tubular. The PHM 182 then moves (e.g., with movement along directions 188, 190, and/or 192) while grasping the tubular with the clamps 186, places the tubular in the fingerboard 184, and releases the tubular to store the tubular in the fingerboard 184.

Once the tubular that was suspended by the elevator 136 is clear from the top drive 116, the top drive 116 is lowered, and the elevator 136 is closed around and grasps the upper portion of the drillstring 106 projecting above the reciprocating slip 180 and/or rig floor 112. The reciprocating slip 180 is then opened, and the elevator 136 is raised using the hoisting equipment to raise the drillstring 106. Once raised, the reciprocating slip 180 is closed to clamp the drillstring 106. The iron roughneck 170 moves to the drillstring 106 and breaks out a connection between tubulars, as described above. The PHM 182 then grasps the suspended tubular and places the tubular in the fingerboard 184, as described above. This process can be repeated until a full length of the drillstring 106 is removed from the wellbore 104.

To trip in the drillstring 106, the process described above for tripping out the drillstring 106 is reversed. To summarize, the PHM 182 grasps a tubular (e.g., tubular 194) from the fingerboard 184 and transfers the tubular to the elevator 136 that closes around and grasps the tubular. If no portion of the drillstring 106 has been advanced into the wellbore 104, the suspended tubular is advanced into the wellbore 104 by lowering the elevator 136. If a portion of the drillstring 106 has been advanced into the wellbore 104, the drillstring 106 will be projecting above the reciprocating slip 180 and/or rig floor 112, and the reciprocating slip 180 will be in a closed position clamping the drillstring 106. The iron roughneck 170 then moves to the drillstring 106 and makes up a connection between the drillstring 106 and the suspended tubular, as described above. The reciprocating slip 180 is then opened and the elevator 136 is lowered to advance the drillstring 106 into the wellbore 104. Once the drillstring 106 has been advanced into the wellbore 104 such that the upper portion of the drillstring 106 is near to the reciprocating slip 180, the reciprocating slip 180 is closed to clamp the drillstring 106, and the elevator 136 is opened to release the drillstring 106. The process is repeated until the drillstring 106 is advanced into the wellbore 104 such that the drill bit 110 contacts the bottom of the wellbore 104. The grabber of the top drive 116 clamps the upper tubular of the drillstring 106, and the drive shaft 132 is driven to make up a connection with the drillstring 106. The grabber releases the tubular, and drilling may resume.

A power distribution center 196 is also at the well site. The power distribution center 196 includes one or more generators, one or more AC-to-DC power converters, one or more DC-to-AC power inverters, one or more hydraulic systems, one or more pneumatic systems, the like, or a combination thereof. The power distribution center 196 can distribute AC and/or DC electrical power to various motors, pumps, or the like that are throughout the drilling system 100. Similarly, the power distribution center 196 can distribute pneumatic and/or hydraulic power throughout the drilling system 100. Components of the power distribution center 196 can be centralized in the drilling system 100 or can be distributed throughout the drilling system 100.

A rig control center 198 is also at the well site. The rig control center 198 houses one or more processing systems that monitor and control the operations of the drilling system 100. Details of the control and monitoring of the operations of the drilling system 100 are described below. Generally, various subsystems of the drilling system 100, such as the drilling fluid circulation system, the hoisting equipment, the top drive 116, the PHM 182, the catwalk 166, etc., can have various sensors and controllers to monitor and control the operations of those subsystems. Some examples are described in further detail below. Additionally, the rig control center 198 can receive information regarding the formation and/or downhole conditions from modules and/or components of the BHA 108 and/or wellbore position information. Furthermore, the rig control center 198 can receive information regarding an operation plan.

The BHA 108 can comprise various components with various capabilities, such as measuring, processing, and storing information. A telemetry device can be in the BHA 108 to enable communications with the rig control center 198. The BHA 108 shown in FIG. 1 is depicted as having a modular construction with specific components in certain modules. However, the BHA 108 may be unitary or select portions thereof may be modular. The modules and/or the components therein may be positioned in a variety of configurations throughout the BHA 108. The BHA 108 may comprise a measurement while drilling (MWD) module 200 that may include tools operable to measure wellbore trajectory, wellbore temperature, wellbore pressure, and/or other example properties. The BHA 108 may comprise a sampling while drilling (SWD) system comprising a sample module 202 for communicating a formation fluid through the BHA 108 and obtaining a sample of the formation fluid. The SWD system may comprise gauges, sensor, monitors and/or other devices that may also be utilized for downhole sampling and/or testing of a formation fluid. The BHA 108 may comprise a logging while drilling (LWD) module 204 that may include tools operable to measure formation parameters and/or fluid properties, such as resistivity, porosity, permeability, sonic velocity, optical density, pressure, temperature, and/or other example properties.

A person of ordinary skill in the art will readily understand that a drilling system may include more or fewer components than what was described above and depicted in FIG. 1. Additionally, various components and/or systems of the drilling system 100 in FIG. 1 may include more or fewer components. For example, various engines, motors, hydraulics, actuators, valves, or the like that were not described with respect to or depicted in FIG. 1 may be included in different components and/or systems; however, such components are within the scope of the present disclosure.

Additionally, the drilling system 100 of FIG. 1 may be implemented as a land-based rig or on an off-shore rig. One or more aspects of the drilling system 100 of FIG. 1 may be incorporated in and/or omitted from a land-based rig or an off-shore rig. Such modifications are within the scope of the present disclosure.

Even further, one or more components and/or systems of the drilling system 100 of FIG. 1 may be transferrable via a land-based movable vessel, such as a truck and/or trailer. As examples, each of the following components and/or systems may be transferrable by a separate truck and trailer combination: the mast 114, the PHM 182 (and associated frame), the drawworks 124, the fingerboard 184, the power distribution center 196, the rig control center 198, and mud tanks 164 (and associated pump 142, shale shaker 160, and reconditioning equipment 162), the catwalk 166, etc. Some of the components and/or systems may be collapsible to accommodate transfer on a trailer. For example, the mast 114 can be telescopic; the fingerboard 184 can collapse; and the catwalk 166 can fold. Other components and/or systems may be collapsible by other techniques or may not be collapsible.

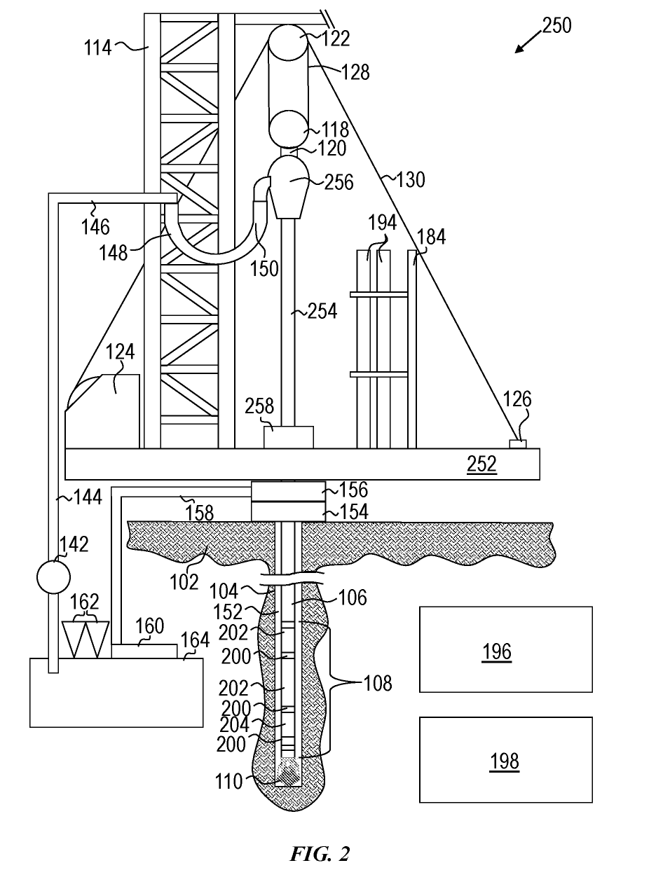

FIG. 2 is a schematic view of at least a portion of an example implementation of a drilling system 250 operable to drill a wellbore 104 into one or more subsurface formations 102 at a well site in accordance with one or more aspects of the present disclosure. Some of the components and operation of those components are common (as indicated by usage of common reference numerals) between the drilling systems 100 and 250 of FIGS. 1 and 2, respectively. Hence, discussion of the common components may be omitted here for brevity, although a person of ordinary skill in the art will readily understand the components and their operation, with any modification, in the drilling system 250 of FIG. 2.

The drilling system 250 includes a mast 114 (at least a portion of which is depicted in FIG. 2) extending from a rig floor 252 that is over the wellbore 104. A swivel 256 and kelly 254 are suspended from the mast 114 and are mechanically coupled to the drillstring 106. A kelly spinner is between the kelly 254 and the swivel 256, although not specifically illustrated. The kelly 254 extends through a master bushing (not specifically depicted) in the rig floor 252 and a kelly bushing 258 that engages the master bushing and the kelly 254. The rig floor 252 includes a rotary table that includes the master bushing and a prime mover. The prime mover of the rotary table, through the master bushing and the kelly bushing 258, provides a rotational force to drive rotational movement of the drillstring 106, which may advance the drillstring 106 into the formation and form the wellbore 104.

The drilling system 250 includes hoisting equipment similar to what is depicted in FIG. 1 and described above. The hook 120 of the traveling block 118 mechanically couples the swivel 256. The drawworks 124 and the deadline anchor 126 are on and supported by the rig floor 252.

The drilling system 250 includes a drilling fluid circulation system similar to what is depicted in FIG. 1 and described above. The pump 142 delivers drilling fluid through a discharge line 144, stand pipe 146, rotary hose 148, and a gooseneck 150 to the swivel 256. The swivel 256 directs the drilling fluid through the kelly 254 and the tubulars of the drillstring 106, and the drilling fluid exits the drillstring 106 via ports in the drill bit 110. The drilling fluid then circulates upward through the annulus 152 defined between the outside of the drillstring 106 and the wall of the wellbore 104. The drilling fluid can be passed through, e.g., a shale shaker 160, reconditioning equipment 162, one or more mud tanks 164, pump 142, or the like, as described above.

Although not illustrated, tongs, a cathead, and/or a spinning wrench or winch spinning system may be used for making up and/or breaking out connections of tubulars. A winch spinning system may include a chain, rope, or the like that is driven by a winch. The spinning wrench or winch spinning system can be used to apply low torque spinning to make up and/or break out a threaded connection between tubulars of the drillstring 106. For example, with a winch spinning system, a roughneck can wrap a chain around a tubular, and the chain is pulled by the winch to spin the tubular to make up and/or break out a connection. The tongs and cathead can be used to apply a high torque to make up and/or break out the threaded connection. For example, a roughneck can manually apply tongs on tubulars, and the cathead mechanically coupled to the tongs (such as by chains) can apply a high torque to make up and/or break out the threaded connection. Additionally, removable slips may be used in securing the drillstring 106 when making up and/or breaking out a connection. The removable slips may be placed by a roughneck between the drillstring 106 and the rig floor 252 and/or master bushing of the rotary table to suspend the drillstring 106 in the wellbore 104.

In operation, the hoisting equipment lowers the drillstring 106 while the prime mover of the rotary table, through the master bushing and kelly bushing 258, rotates the drillstring 106 to advance the drillstring 106 downward in the wellbore 104. During the advancement of the drillstring 106, the removable slips are removed, and the tongs are clear of the drillstring 106. When the upper portion of the kelly 254 nears the kelly bushing 258 and/or rig floor 252, the rotary table ceases rotating the drill string 106. The hoisting equipment raises the kelly 254 until the upper portion of the drillstring 106 protrudes from the master bushing and/or rig floor 252, and the slips are placed between the drillstring 106 and the master bushing and/or rig floor 252 to clamp the drillstring 106. When the kelly 254 is raised, a flange at the bottom of the kelly 254 can grasp the kelly bushing 258 to clear the kelly bushing 258 from the master bushing. Roughnecks then can break out the connection between the kelly 254 and the drillstring 106 using the tongs and cathead for applying a high torque, and the prime mover of the rotary table can cause the drillstring 106 to rotate to spin out of the connection to the kelly 254, for example.

A tubular may be positioned in preparation to being made up to the kelly 254 and the drillstring 106. For example, a tubular may be manually transferred to a mouse hole in the rig floor 252. Other methods and systems for transferring a tubular may be used.

With the connection between the drillstring 106 and the kelly 254 broken out, the hoisting equipment maneuvers the kelly 254 into a position such that a connection between the kelly 254 and the tubular projecting through the mouse hole can be made up. Roughnecks then can make up the connection between the kelly 254 and the tubular by spinning the kelly 254 with the kelly spinner to apply a low torque and by using the tongs and cathead to apply a high torque. The hoisting equipment then raises and maneuvers the kelly 254 and attached tubular into a position such that a connection between the attached tubular and drillstring 106 can be made up. Roughnecks then can make up the connection between the tubular and the drillstring 106 by clamping one of the tongs to the tubular and spinning the kelly 254 with the kelly spinner to apply a low torque and by using the tongs and cathead to apply a high torque. The slips are then removed, and the drillstring 106 and kelly 254 are lowered by the hoisting equipment until the drill bit 110 engages the formation 102. The kelly bushing 258 engages the master bushing and the kelly 254, and the prime mover of the rotary table beings providing rotational movement to the drillstring 106 to resume drilling.

To trip out and to trip in the drillstring 106, the kelly 254 and/or the swivel 256 can be decoupled from the hoisting equipment (e.g., removed from the hook 120), and an elevator may be mechanically coupled to the hoisting equipment (e.g., the hook 120). In some examples, an elevator is attached to and/or part of the hook 120.

To trip out the drillstring 106, the hoisting equipment raises the swivel 256 and kelly 254 until the upper portion of the drillstring 106 projects from the master bushing and/or rig floor 252, and the slips are placed between the drillstring 106 and the master bushing and/or rig floor 252 to clamp the drillstring 106. The connection between the drillstring 106 and kelly 254 is broken out, as described above, and the kelly 254 and/or swivel 256 are decoupled from the hook 120 and are placed aside.

The hoisting equipment lowers the elevator to the drillstring 106, and the elevator is closed around the drillstring 106 to grasp the drillstring. The slips are removed, and the hoisting equipment raises the elevator and the drillstring 106 such that the upper tubular(s) of the drillstring 106 is suspended above the rig floor 252. The slips are placed between the drillstring 106 and the master bushing and/or rig floor 252 to clamp the drillstring 106. Roughnecks then can break out a connection between the suspended tubular and the drillstring 106 by using the tongs and cathead to apply a high torque and by using the spinning wrench and/or winch spinning system to apply a low torque. A derrickman, e.g., on a monkeyboard, then transfers the suspended tubular to the fingerboard 184. This process can be repeated until a full length of the drillstring 106 is removed from the wellbore 104.

To trip in the drillstring 106, the process described above for tripping out the drillstring 106 is reversed. To summarize, a derrickman transfers a tubular (e.g., tubular 194) from the fingerboard 184 to the elevator that closes around and grasps the tubular. If no portion of the drillstring 106 has been advanced into the wellbore 104, the suspended tubular is advanced into the wellbore 104 by lowering the elevator. If a portion of the drillstring 106 has been advanced into the wellbore 104, the drillstring 106 will be projecting above the master bushing and/or rig floor 252, and the slips will be positioned around the drillstring 106 clamping the drillstring 106. Roughnecks then can make up a connection between the suspended tubular and the drillstring 106 by using the spinning wrench and/or winch spinning system to apply a low torque and by using the tongs and cathead to apply a high torque. The slips are then removed, and the drillstring 106 is lowered by the hoisting equipment into the wellbore 104. Once the drillstring 106 has been advanced into the wellbore 104 such that the upper portion of the drillstring 106 is near to the master bushing and/or rig floor 252, the slips are placed between the drillstring 106 and the master bushing and/or rig floor 252 to clamp the drillstring 106, and the elevator is opened to release the drillstring 106. The process is repeated until the drillstring 106 is advanced into the wellbore 104 such that the drill bit 110 contacts the bottom of the wellbore 104. The kelly 254 and swivel 256 are then mechanically coupled to the hoisting equipment, and a connection is made up between the kelly 254 and drillstring as described above. Drilling may resume.

A power distribution center 196 and rig control center 198 are also at the well site as described above. The rig control center 198 houses one or more processing systems that monitor and control the operations of the drilling system 250. Details of the control and monitoring of the operations of the drilling system 250 are described below. Generally, various subsystems of the drilling system 250, such as the drilling fluid circulation system, the hoisting equipment, the rotary table, etc., can have various sensors and controllers to monitor and control the operations of those subsystems similar to as described above. Additionally, the rig control center 198 can receive information regarding the formation and/or downhole conditions from modules and/or components of the BHA 108. The BHA 108 can comprise various components with various capabilities, such as measuring, processing, and storing information, as described above.

A person of ordinary skill in the art will readily understand that a drilling system may include more or fewer components than what was described above and depicted in FIG. 2. Additionally, various components and/or systems of the drilling system 250 in FIG. 2 may include more or fewer components. For example, various engines, motors, hydraulics, actuators, valves, or the like that were not described with respect to or depicted in FIG. 2 may be included in different components and/or systems; however, such components are within the scope of the present disclosure.

Additionally, the drilling system 250 of FIG. 2 may be implemented as a land-based rig or on an off-shore rig. One or more aspects of the drilling system 250 of FIG. 2 may be incorporated in and/or omitted from a land-based rig or an off-shore rig. Such modifications are within the scope of the present disclosure.

Even further, one or more components and/or systems of the drilling system 250 of FIG. 2 may be transferrable via a land-based movable vessel, such as a truck and/or trailer. As examples, each of the following components and/or systems may be transferrable by a separate truck and trailer combination: the mast 114, the drawworks 124, the fingerboard 184, the power distribution center 196, the rig control center 198, and mud tanks 164 (and associated pump 142, shale shaker 160, and reconditioning equipment 162), etc. Some of the components and/or systems may be collapsible to accommodate transfer on a trailer. For example, the mast 114 can be telescopic, and the fingerboard 184 can collapse. Other components and/or systems may be collapsible by other techniques or may not be collapsible.

The drilling systems 100 and 250 of FIGS. 1 and 2, respectively, illustrate various example components and systems that may be incorporated in a drilling system. Various other example drilling systems may include any combination of components and systems described with respect to the drilling systems 100 and 250 of FIGS. 1 and 2, respectively, and may omit some components and/or systems and/or include additional components and/or systems not specifically described herein. Such drilling systems are within the scope of the present disclosure.

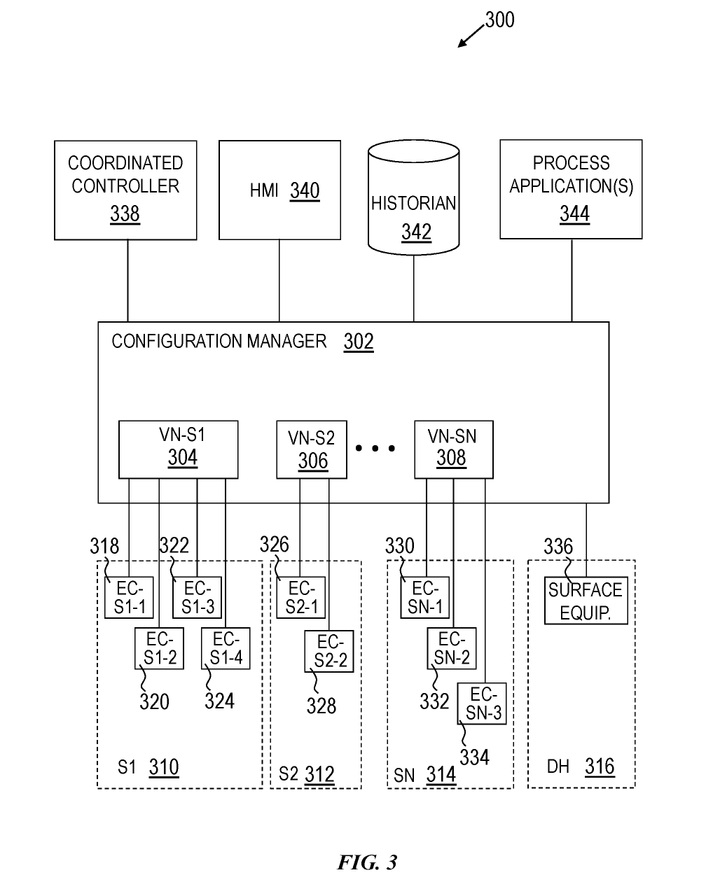

FIG. 3 is a schematic view of at least a portion of an example implementation of an operations network 300 according to one or more aspects of the present disclosure. The physical network used to implement the operations network 300 of FIG. 3 can have any network topology, such as a bus topology, a ring topology, a star topology, mesh topology, etc. The operations network 300 can include one or more processing systems, such as one or more network appliances (like a switch or other processing system), that is configured to implement various virtual networks, such as virtual local area networks (VLANs).

The operations network 300 includes a configuration manager 302, which may be a software program instantiated and operable on one or more processing systems, such as one or more network appliances. The configuration manager 302 may be a software program written in and compiled from a high-level programming language, such as C/C++ or the like. As described in further detail below, the configuration manager 302 is operable to translate communications from various communications protocols to a common communication protocol and make the communications translated to the common communication protocol available through a common data bus, and vice versa. The common data bus may include an application program interface (API) of the configuration manager 302 and/or a common data virtual network (VN-DATA) implemented on one or more processing systems, such as network appliances like switches.

One or more processing systems of the operations network 300, such as one or more network appliance like switches, are configured to implement one or more subsystem virtual networks (e.g., VLANs), such as a first subsystem virtual network (VN-S1) 304, a second subsystem virtual network (VN-S2) 306, and an Nth subsystem virtual network (VN-SN) 308 as illustrated in FIG. 3. More or fewer subsystem virtual networks may be implemented. The subsystem virtual networks (e.g., VN-S1 304, VN-S2 306, and VN-SN 312) are logically separate from each other. The subsystem virtual networks can be implemented according to the IEEE 802.1Q standard, another standard, or a proprietary implementation. Each of the subsystem virtual networks can implement communications with the EC(s) of the respective subsystem based on any protocol, such as any Ethernet-based network protocol (such as ProfiNET, OPC, OPC/UA, Modbus TCP/IP, EtherCAT, UDP multicast, Siemens S7 communication, or the like), a proprietary communication protocol, and/or another communication protocol. Further, the subsystem virtual networks can implement publish-subscribe communications. The subsystem virtual networks can implement the same protocol, each subsystem virtual network can implement a different protocol, or any combination therebetween.

In the illustrated example of FIG. 3, a first control subsystem (S1) 310, a second control subsystem (S2) 312, and an Nth control subsystem (SN) 314 are various control subsystems of a drilling system. Example subsystems include a drilling fluid circulation system (which may include mud pumps, valves, fluid reconditioning equipment, etc.), a rig control system (which may include hoisting equipment, drillstring rotary mover equipment (such as a top drive and/or rotary table), a PHM, a catwalk, etc.), a managed pressure drilling system, a cementing system, a rig walk system, etc. A subsystem may include a single piece of equipment or may include multiple pieces of equipment, e.g., that are jointly used to perform one or more function. Each subsystem includes one or more ECs, which may control equipment and/or receive sensor and/or status data from sensors and/or equipment. In the illustrated example of FIG. 3, the S1 310 includes a first S1 EC (EC-S1-1) 318, a second S1 EC (EC-S1-2) 320, a third S1 EC (EC-S1-3) 322, and a fourth S1 EC (EC-S1-4) 324. The S2 312 includes a first S2 EC (EC-S2-1) 326 and a second S2 EC (EC-S2-2) 328. The SN 314 includes a first SN EC (EC-SN-1) 330, a second SN EC (EC-SN-2) 332, and a third SN EC (EC-SN-3) 334. Any number of control subsystems may be implemented, and any number of ECs may be used in any control subsystem. Some example control subsystems are described below following description of various aspects of FIG. 3.

Each EC can implement logic to monitor and/or control one or more sensors and/or one or more controllable components of the respective subsystem. Each EC can include logic to interpret a command and/or other data, such as from one or more sensors or controllable components, and to communicate a signal to one or more controllable components of the subsystem to control the one or more controllable components in response to the command and/or other data. Each EC can also receive a signal from one or more sensors, can reformat the signal, such as from an analog signal to a digital signal, into interpretable data. The logic for each EC can be programmable, such as compiled from a low level programming language, such as described in IEC 61131 programming languages for PLCs, structured text, ladder diagram, functional block diagrams, functional charts, or the like.

Further in the illustrated example of FIG. 3, a downhole system (DH) 316 is an example sensor system of the drilling system. The DH 316 includes surface equipment 336 that is communicatively coupled to a bottom hole assembly (BHA) on a drillstring (e.g., the BHA 108 of the drillstring 106 in FIGS. 1 and 2). The surface equipment 336 receives data from the BHA relating to conditions in the wellbore. The surface equipment 336 in this example does not control operations of any equipment. Other sensor subsystems can be included in the operations network 300. Any number of sensor subsystems may be implemented.

The operations network 300 includes a coordinated controller 338, which may be a software program instantiated and operable on one or more processing systems, such as one or more network appliances. The coordinated controller 338 may be a software program written in and compiled from a high-level programming language, such as C/C++ or the like. The coordinated controller 338 can control operations of subsystems and communications between subsystems as described in further detail below.

The operations network 300 also includes one or more human-machine interfaces (HMIs), which as illustrated includes HMI 340. The HMI 340 can may be, comprise, or be implemented by one or more processing system with a keyboard, a mouse, a touchscreen, a joystick, one or more control switches or toggles, one or more buttons, a track-pad, a trackball, an image/code scanner, a voice recognition system, a display device (such as a liquid crystal display (LCD), a light-emitting diode (LED) display, and/or a cathode ray tube (CRT) display), a printer, speaker, and/or other examples. The HMI 340 may allow for entry of commands to the coordinated controller 338 and for visualization or other sensory perception of various data, such as sensor data, status data, and/or other example data. In some examples, an HMI may be a part of a control subsystem and can issue commands through a subsystem virtual network to one or more of the ECs of that subsystem virtual network without using the coordinated controller 338. Each HMI can be associated with and control a single or multiple subsystems. In a further example, an HMI can control an entirety of the system that includes each subsystem.

The operations network 300 also includes a historian 342, which may be a database maintained and operated on one or more processing systems, such as database devices, for example. The historian 342 can be distributed across multiple processing systems and/or may be maintained in memory, which can include external storage, such as a hard disk or drive. The historian 342 may access sensor data and/or status data, which is stored and maintained in the historian 342.

The operations network 300 further includes one or more process applications 344, which may be a software program instantiated and operable on one or more processing systems, such as one or more network appliances, such as server devices. The process applications 344 may each be a software program written in and compiled from a high-level programming language, such as C/C++ or the like. The process applications 344 may analyze data and output information to, e.g., construction personnel to inform various construction operations. In some examples, the process applications 344 can output commands for various ECs for controlling construction operations.

Referring to communications within the operations network 300, each EC within a control subsystem can communicate with other ECs in that control subsystem through the subsystem virtual network for that control subsystem (e.g., through processing systems configured to implement the subsystem virtual network). Sensor data, status data, and/or commands from an EC in a subsystem can be communicated to another EC within that subsystem through the subsystem virtual network for that subsystem, for example, which may occur without intervention of the coordinated controller 338. As an example from the example operations network 300 in FIG. 3, EC-S1-1 318 can communicate sensor data, status data, and/or commands to EC-S1-3 322 through VN-S1 304, and vice versa. Other ECs within a subsystem can similarly communicate through their respective subsystem virtual network.

Communications from a subsystem virtual network to another processing system outside of that subsystem and respective subsystem virtual network can be translated from the communications protocol used for that subsystem virtual network to a common protocol, such as data distribution service (DDS) protocol or another, by the configuration manager 302. The communications that are translated to a common protocol can be made available to other processing systems through the common data bus, for example. Sensor data and/or status data from the control subsystems (e.g., S1 310, S2 312, and SN 314) may be available (e.g., directly available) for consumption by, e.g., ECs of different subsystems, the coordinated controller 338, HMI 340, historian 342, and/or process applications 344 from the common data bus. ECs can communicate sensor data and/or status data to another EC in another subsystem through the common data bus. For example, if a sensor in the S1 310 communicates a signal to the EC-S1-1 318 and the data generated from that sensor is also used by the EC-S2-1 326 in the S2 312 to control one or more controllable components of the S2 312, the sensor data can be communicated from the EC-S1-1 318 through the VN-S1 304, the common data bus, and VN-S2 306 to the EC-S2-1 326. Other ECs within various subsystems can similarly communicate sensor data and/or status data through the common data bus to one or more other ECs in different subsystems. Similarly, for example, if one or more of the process applications 344 consume data generated by a sensor coupled to the EC-S1-1 318 in the S1 310, the sensor data can be communicated from the EC-S1-1 318 through the VN-S1 304 and the common data bus, where the one or more process applications 344 can access and consume the sensor data.

Similarly, communications from a sensor subsystem (e.g., the DH 316) can be translated from the communications protocol used for that sensor subsystem to the common protocol by the configuration manager 302. The communications that are translated to a common protocol can be made available to other processing systems through the common data bus, for example. Similar to above, sensor data and/or status data from the sensor subsystem may be available (e.g., directly available) for consumption by, e.g., ECs of control subsystems, the coordinated controller 338, HMI 340, historian 342, and/or process applications 344 from the common data bus.

The coordinated controller 338 can control issuance of commands to ECs from a source outside of the ECs' respective subsystem virtual network. For example, one or more ECs can issue a command to one or more ECs in another subsystem through respective subsystem virtual networks and the common data bus under the control of the coordinated controller 338. As another example, the HMI 340 and/or process applications 344 can issue a command to one or more ECs in a subsystem through the common data bus under the control of the coordinated controller 338 and through the subsystem virtual network of that subsystem. For example, a user may input commands through the HMI 340 to control an operation of a subsystem. Commands to an EC of a subsystem from a source outside of that subsystem may be prohibited in the operations network 300 without the coordinated controller 338 processing the command. The coordinated controller 338 can implement logic to determine whether a given EC of one subsystem, the HMI 340, and/or process applications 344 can issue a command to another given EC in a different subsystem.

The coordinated controller 338 can implement logic to arbitrate the operation of particular equipment or subsystem, such as when there are multiple actors (e.g., ECs and/or HMIs) attempting to send commands to the same equipment or subsystem at the same time. The coordinated controller 338 can implement logic to determine which of conflicting commands from HMIs and/or ECs of different subsystems to issue to another EC. For example, if EC-S1-1 318 issues a command to EC-SN-1 330 to increase a pumping rate of a pump, and EC-S2-1 326 issues a command to EC-SN-1 330 to decrease the pumping rate of the same pump simultaneously, the coordinated controller 338 will resolve the conflict and determines which command (from EC-S1-1 318 or EC-S2-1 326) is allowed to proceed. Additionally, as an example, if two HMIs issue conflicting commands simultaneously, the coordinated controller 338 can determine which command to prohibit and which command to issue.

The coordinated controller 338 can also implement logic to control operations of the drilling system. The coordinated controller 338 can monitor various statuses of components and/or sensors and can issue commands to various ECs to control the operation of the controllable components within one or more subsystem. Sensor data and/or status data can be monitored by the coordinated controller 338 through the common data bus, and the coordinated controller 338 can issue commands to one or more ECs through the respective subsystem virtual network of the EC.

Other configurations of an operations network are also within the scope of the present disclosure. Different numbers of ECs, different numbers of subsystems and subsystem virtual networks, and different physical topologies and connections are within the scope of the present disclosure. Additionally, other example implementations may include or omit an HMI and/or a historian, for example.

Using a configuration manager, such as the configuration manager 302 in FIG. 3, can allow for simpler deployment of subsystems in a drilling system and associated communications equipment, for example. The use of a software program compiled from a high level language can allow for deployment of an updated version of a configuration manager when an additional subsystem is deployed, which may alleviate deployment of physical components associated with the configuration manager. Further, applications that access data from the configuration manager (e.g., through the common data bus) can be updated through a software update when new data becomes available by the addition of a new subsystem, such that the updated application can consume data generated by the new subsystem.

As an example subsystem, a drilling fluid circulation system can incorporate one or more ECs that control one or more controllable components. Controllable components in the drilling fluid circulation system may include one or more pumps (e.g., pump 142 in FIGS. 1 and 2), a shale shaker (e.g., shale shaker 160), a desilter, a desander, a degasser (e.g., reconditioning equipment 162), a hopper, various valves that may be on pipes and/or lines, and other components. For example, a pump may be controllable by an EC to increase/decrease a pump rate by increasing/decreasing revolutions of a prime mover driving the pump, and/or to turn the pump on/off. Similarly, a shale shaker may be controllable by an EC to increase/decrease vibrations of a grating, and/or to turn on/off the shale shaker. A degasser may be controllable by an EC to increase/decrease a pressure in the degasser by increasing/decreasing revolutions of a prime mover of a vacuum pump of the degasser, and/or to turn on/off the degasser. A hopper may be controllable by an EC to open/close a valve of the hopper to control the release of an additive (e.g., caustic soda) into a pipe and/or line through which drilling fluid flows. Further, various relief valves, such as a relief discharge value on a discharge line of a drilling fluid pump, a relief suction valve on an intake or suction line of a drilling fluid pump, or the like, may be controllable by an EC to be opened/closed to relieve pressure. The controllable components may be controlled by a digital signal and/or analog signal from an EC. A person of ordinary skill in the art will readily envisage other example controllable components in a drilling fluid circulation system and how such components would be controllable by an EC, which are within the scope of the present disclosure.

The drilling fluid circulation system can also incorporate one or more ECs that receive one or more signals from one or more sensors that are indicative of conditions in the drilling fluid circulation system. The one or more ECs that control one or more controllable components may be the same as, different from, or any combination therebetween the one or more ECs that receive signals from sensors. As some examples of sensors, various flow meters and/or pressure gauges can be fluidly coupled to various lines and/or pipes through which drilling fluid flows, such as the discharge line of a drilling fluid pump, the standpipe, the return line, the intake line of the drilling fluid pump, around various equipment, and/or the like. Using flow meters and/or pressure gauges, flow rates and/or pressure differentials may be determined that can indicate a leak in equipment, that a clog in equipment has occurred, that the formation has kicked, that drilling fluid is being lost to the formation, or the like. Various tachometers can be on various pumps and/or prime movers to measure revolutions, such as of a drilling fluid pump, a vacuum pump of a degasser, a motor of an agitator of a mud tank, or the like. The tachometers can be used to measure the health of the respective equipment. A pressure gauge can be on the degasser to measure a pressure within the degasser. The degasser may operate at a predetermined pressure level to adequately remove gas from drilling fluid, and a pressure reading from a pressure gauge can be fed back to control the pressure within the degasser. A pit volume totalizer can be in one or more mud tanks to determine an amount of drilling fluid held by the mud tanks, which can indicate a leak in equipment, that a clog in equipment has occurred, that the formation has kicked, that drilling fluid is being lost to the formation, or the like. A viscometer can be along the circulation to measure viscosity of the drilling fluid, which can be used to determine remedial action, such as adding an additive to the drilling fluid at a hopper. Signals from such sensors can be sent to and received by one or more ECs, which can then transmit the sensor data to the common data bus and/or use the data to responsively control controllable components, for example. The signals from the sensor that are received by an EC may be a digital signal and/or analog signal. A person of ordinary skill in the art will readily envisage other example sensors in a drilling fluid circulation system and how such components would be coupled to an EC, which are within the scope of the present disclosure.

As another example, a rig control system can incorporate one or more ECs that control one or more controllable components. Controllable components of the hoisting equipment may include a prime mover of the drawworks, one or more brake, and others. For example, a prime mover of the drawworks may be controllable by an EC to increase/decrease a revolution rate of the prime mover of the drawworks, and/or to turn the prime mover on/off. A mechanical brake may be controllable by an EC to actuate the brake (e.g., a caliper and pad assembly) to clamp/release a brake disk of the drawworks, for example.

Controllable components in the drillstring rotary mover equipment may include a prime mover (e.g., including the top drive 116 in FIG. 1 and/or the rotary table in the rig floor 252 in FIG. 2), a gear box and/or transmission, a pipe handler assembly and/or grabber, a kelly spinner, a torque wrench, a reciprocating slip, or others. For example, the prime mover may be controllable by an EC to increase/decrease a revolution rate of the prime mover, and/or to turn the prime mover on/off. The gear box and/or transmission may be controllable by an EC to set and/or change a gear ratio between the prime mover and the drive shaft or master bushing. The pipe handler assembly and/or grabber can be controllable by an EC to move the pipe handler assembly and/or grabber into a position for receiving, setting, etc. a tubular and for clasping and/or releasing a tubular. The kelly spinner can be controllable by an EC to rotate a kelly when making up or breaking out a connection between the kelly and the drillstring. The torque wrench can be controllable by an EC to clamp and twist a tubular to make up a connection between the drive shaft and the tubular. The reciprocating slip can be controllable by an EC to open/close the reciprocating slip.

The controllable components may be controlled by a digital signal and/or analog signal from an EC. A person of ordinary skill in the art will readily envisage other example controllable components in a rig control system and how such components would be controllable by an EC, which are within the scope of the present disclosure.

The rig control system can also incorporate one or more ECs that receive one or more signals from one or more sensors that are indicative of conditions in the rig control system. The one or more ECs that control one or more controllable components may be the same as, different from, or any combination therebetween the one or more ECs that receive signals from sensors. As some examples of sensors, a crown saver can be in a drawworks to determine and indicate when an excessive amount of drilling line has been taken in by the drawworks. An excessive amount of drilling line being taken in can damage hoisting equipment, such as by a traveling block impacting a crown block, and hence, the signal from the crown saver can be fed back to indicate when the drawworks should cease taking in drilling line. A weight-on-bit sensor can be included on, e.g., the traveling block, drawworks, deadline, etc., and/or combinations thereof. The signal from the weight-on-bit sensor can be fed back to determine if too much or too little weight is on the bit of the drillstring, and in response, to determine whether to take in or reel out, respectively, drilling line. Further, a tachometer can be on a prime mover of the drawworks to measure revolutions. The tachometer can be used to measure the health of the prime mover.

As some further examples of sensors, various tachometers can be on the prime mover and/or drive shaft or master bushing of drillstring rotary mover equipment that can be used to determine a rate of rotation of the respective prime mover and/or drive shaft or master bushing. A torque-on-bit sensor can be in a BHA, for example. Various pressure gauges scan be coupled to hydraulics systems used for the pipe handler assembly and/or grabber, the torque wrench, the reciprocating slip, and/or the like.

Signals from such sensors can be sent to and received by one or more ECs, which can then transmit the sensor data to the common data bus and/or use the data to responsively control controllable components, for example. The signals from the sensor that are received by an EC may be a digital signal and/or analog signal. A person of ordinary skill in the art will readily envisage other example sensors in a rig control system and how such components would be coupled to an EC, which are within the scope of the present disclosure.

A person of ordinary skill in the art will readily understand other example subsystems that may be in a drilling system, which subsystems are within the scope of the present disclosure. Additional example subsystems include a managed pressure drilling system, a cementing system, a rig walk system, etc. A person of ordinary skill in the art will readily understand example EC(s), controllable component(s), and/or sensor(s) that can be used in these additional example systems. Additionally, a person of ordinary skill in the art will readily understand other example equipment and components that may be included in or omitted from example subsystems described herein.

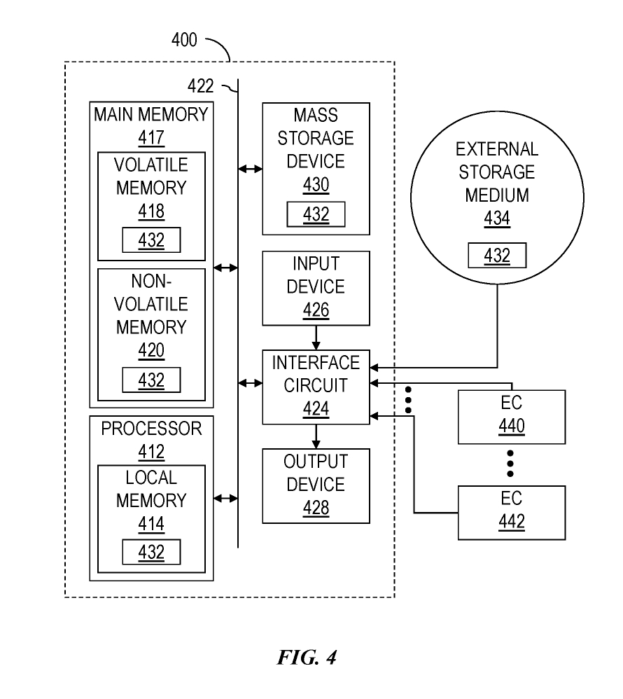

FIG. 4 is a schematic view of at least a portion of an example implementation of a first processing system 400 according to one or more aspects of the present disclosure. The first processing system 400 may execute example machine-readable instructions to implement at least a portion of the configuration manager, coordinated controller, virtual networks, HMI, and/or historian described herein.

The first processing system 400 may be or comprise, for example, one or more processors, controllers, special-purpose computing devices, industrial computers, servers, personal computers, internet appliances, PLCs, and/or other types of computing devices. Moreover, while it is possible that the entirety of the first processing system 400 shown in FIG. 4 is implemented within one device, e.g., in the rig control center 198 of FIGS. 1 and 2, it is also contemplated that one or more components or functions of the first processing system 400 may be implemented across multiple devices, some or an entirety of which may be at the well site and/or remote from the well site of the drilling systems 100 and 250 of FIGS. 1 and 2, respectively.

The first processing system 400 comprises a processor 412 such as, for example, a general-purpose programmable processor. The processor 412 may comprise a local memory 414, and may execute program code instructions 432 present in the local memory 414 and/or in another memory device. The processor 412 may execute, among other things, machine-readable instructions or programs to implement the configuration manager, coordinated controller, and/or virtual networks described herein, for example. The programs stored in the local memory 414 may include program instructions or computer program code that, when executed by an associated processor, enable implementation of the configuration manager, coordinated controller, virtual networks, HMI, and/or historian described herein. The processor 412 may be, comprise, or be implemented by one or more processors of various types operable in the local application environment, and may include one or more general-purpose processors, special-purpose processors, microprocessors, digital signal processors (DSPs), field-programmable gate arrays (FPGAs), application-specific integrated circuits (ASICs), processors based on a multi-core processor architecture, and/or other processors. More particularly, examples of a processor 412 include one or more INTEL microprocessors, microcontrollers from the ARM and/or PICO families of microcontrollers, embedded soft/hard processors in one or more FPGAs, etc.

The processor 412 may be in communication with a main memory 417, such as via a bus 422 and/or other communication means. The main memory 417 may comprise a volatile memory 418 and a non-volatile memory 420. The volatile memory 418 may be, comprise, or be implemented by a tangible, non-transitory storage medium, such as random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 420 may be, comprise, or be implemented by a tangible, non-transitory storage medium, such as read-only memory, flash memory and/or other types of memory devices. One or more memory controllers (not shown) may control access to the volatile memory 418 and/or the non-volatile memory 420.

The first processing system 400 may also comprise an interface circuit 424, which is in communication with the processor 412, such as via the bus 422. The interface circuit 424 may be, comprise, or be implemented by various types of standard interfaces, such as an Ethernet interface, a universal serial bus (USB), a third generation input/output (3GIO) interface, a wireless interface, and/or a cellular interface, among other examples. One or more EC (e.g., EC 440 through EC 442 as depicted) are communicatively coupled to the interface circuit 424. The interface circuit 424 can enable communications between the first processing system 400 and one or more EC by enabling one or more communication protocols, such as any Ethernet-based network protocol (such as ProfiNET, OPC, OPC/UA, Modbus TCP/IP, EtherCAT, UDP multicast, Siemens S7 communication, or the like), a proprietary communication protocol, and/or another communication protocol. The interface circuit 424 may also comprise a communication device such as a modem or network interface card to facilitate exchange of data with external computing devices via a network, such as via Ethernet connection, digital subscriber line (DSL), telephone line, coaxial cable, cellular telephone system, and/or satellite, among other examples.

One or more input devices 426 may be connected to the interface circuit 424. One or more of the input devices 426 may permit a user to enter data and/or commands for utilization by the processor 412. Each input device 426 may be, comprise, or be implemented by a keyboard, a mouse, a touchscreen, a joystick, one or more control switches or toggles, one or more buttons, a track-pad, a trackball, an image/code scanner, and/or a voice recognition system, among other examples.

One or more output devices 428 may also be connected to the interface circuit 424. One or more of the output device 428 may be, comprise, or be implemented by a display device, such as a LCD, a LED display, and/or a CRT display, among other examples. The interface circuit 424 may also comprise a graphics driver card to enable used of a display device as one or more of the output device 428. One or more of the output devices 428 may also or instead be, comprise, or be implemented by a printer, speaker, and/or other examples.

The one or more input devices 426 and the one or more output devices 428 connected to the interface circuit 424 may, at least in part, enable the HMI described above with respect to FIG. 3. The input device(s) 426 may allow for entry of commands to the coordinated controller, and the output device(s) 428 may allow for visualization or other sensory perception of various data, such as sensor data, status data, and/or other example data.

The first processing system 400 may also comprise a mass storage device 430 for storing machine-readable instructions and data. The mass storage device 430 may be connected to the processor 412, such as via the bus 422. The mass storage device 430 may be or comprise a tangible, non-transitory storage medium, such as a floppy disk drive, a hard disk drive, a compact disk (CD) drive, and/or digital versatile disk (DVD) drive, among other examples. The program code instructions 432 may be stored in the mass storage device 430, the volatile memory 418, the non-volatile memory 420, the local memory 414, a removable storage medium, such as a CD or DVD, an external storage medium 434, e.g., connected to the interface circuit 424, and/or another storage medium.

The modules and/or other components of the first processing system 400 may be implemented in accordance with hardware (such as in one or more integrated circuit chips, such as an ASIC), or may be implemented as software or firmware for execution by a processor. In the case of firmware or software, the implementation can be provided as a computer program product including a computer readable medium or storage structure containing computer program code (i.e., software or firmware) for execution by the processor.

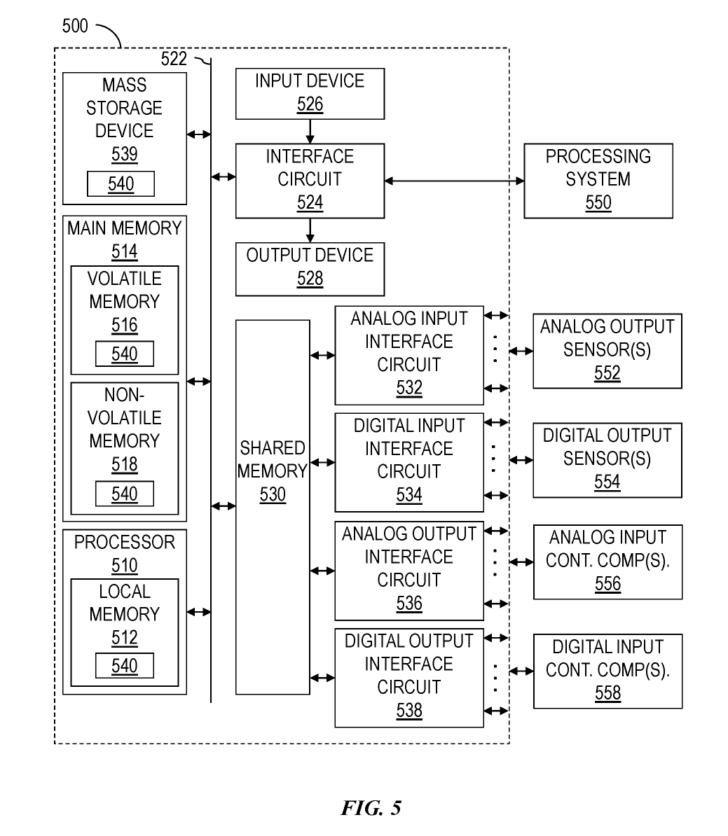

FIG. 5 is a schematic view of at least a portion of an example implementation of a second processing system 500 according to one or more aspects of the present disclosure. The second processing system 500 may execute example machine-readable instructions to implement at least a portion of an EC as described herein.

The second processing system 500 may be or comprise, for example, one or more processors, controllers, special-purpose computing devices, servers, personal computers, internet appliances, and/or other types of computing devices. Moreover, while it is possible that the entirety of the second processing system 500 shown in FIG. 5 is implemented within one device, it is also contemplated that one or more components or functions of the second processing system 500 may be implemented across multiple devices, some or an entirety of which may be at the well site and/or remote from the well site of the drilling systems 100 and 250 of FIGS. 1 and 2, respectively.

The second processing system 500 comprises a processor 510 such as, for example, a general-purpose programmable processor. The processor 510 may comprise a local memory 512, and may execute program code instructions 540 present in the local memory 512 and/or in another memory device. The processor 510 may execute, among other things, machine-readable instructions or programs to implement logic for monitoring and/or controlling one or more components of a drilling system. The programs stored in the local memory 512 may include program instructions or computer program code that, when executed by an associated processor, enable monitoring and/or controlling one or more components of a drilling system. The processor 510 may be, comprise, or be implemented by one or more processors of various types operable in the local application environment, and may include one or more general-purpose processors, special-purpose processors, microprocessors, digital signal processors (DSPs), field-programmable gate arrays (FPGAs), application-specific integrated circuits (ASICs), processors based on a multi-core processor architecture, and/or other processors.

The processor 510 may be in communication with a main memory 514, such as via a bus 522 and/or other communication means. The main memory 514 may comprise a volatile memory 516 and a non-volatile memory 518. The volatile memory 516 may be, comprise, or be implemented by a tangible, non-transitory storage medium, such as RAM, SRAM, SDRAM, DRAM, RDRAM, and/or other types of random access memory devices. The non-volatile memory 518 may be, comprise, or be implemented by a tangible, non-transitory storage medium, such as read-only memory, flash memory and/or other types of memory devices. One or more memory controllers (not shown) may control access to the volatile memory 516 and/or the non-volatile memory 518.

The second processing system 500 may also comprise an interface circuit 524, which is in communication with the processor 510, such as via the bus 522. The interface circuit 524 may be, comprise, or be implemented by various types of standard interfaces, such as an Ethernet interface, a universal serial bus (USB), a peripheral component interconnect (PCI) interface, and a third generation input/output (3GIO) interface, among other examples. One or more other processing system 550 (e.g., the first processing system 400 of FIG. 4) are communicatively coupled to the interface circuit 524. The interface circuit 524 can enable communications between the second processing system 500 and one or more other processing system (e.g., the respective processing systems of the configuration manager 302 and the coordinated controller 338 in FIG. 3) by enabling one or more communication protocols, such as any Ethernet-based network protocol (such as ProfiNET, OPC, OPC/UA, Modbus TCP/IP, EtherCAT, UDP multicast, Siemens S7 communication, or the like), a proprietary communication protocol, and/or another communication protocol.

One or more input devices 526 may be connected to the interface circuit 524. One or more of the input devices 526 may permit a user to enter data and/or commands for utilization by the processor 510. Each input device 526 may be, comprise, or be implemented by a touchscreen, a keypad, a joystick, one or more control switches or toggles, and/or one or more buttons, among other examples.

One or more output devices 528 may also be connected to the interface circuit 524. One or more of the output device 528 may be, comprise, or be implemented by a display device, such as a LCD, and/or a LED display, among other examples. The interface circuit 524 may also comprise a graphics driver card to enable used of a display device as one or more of the output device 528. One or more of the output devices 528 may also or instead be, comprise, or be implemented by one or more individual LEDs, a printer, speaker, and/or other examples.

The second processing system 500 may comprise a shared memory 530, which is in communication with the processor 510, such as via the bus 522. The shared memory 530 may be, comprise, or be implemented by a tangible, non-transitory storage medium, such as RAM, SRAM, SDRAM, DRAM, RDRAM, and/or other types of random access memory devices.

The second processing system 500 may comprise one or more analog input (AI) interface circuits 532, one or more digital input (DI) interface circuits 534, one or more analog output (AO) interface circuits 536, and/or one or more digital output (DO) interface circuits 538, each of which are in communication with the shared memory 530. The AI interface circuit 532 can include one or multiple inputs and can convert an analog signal received on an input into digital data useable by the processor 510, for example. The DI interface circuit 534 can include one or multiple inputs and can receive a discrete signal (e.g., on/off signal), which may be useable by the processor 510. The AI interface circuit 532 and DI interface circuit 534 are communicatively coupled to the shared memory 530, where the AI interface circuit 532 and DI interface circuit 534 can cache and/or queue input data and from which the processor 510 can access the data. The inputs of the AI interface circuit 532 and DI interface circuit 534 are communicatively coupled to outputs of various sensors (e.g., analog output sensor 552 and digital output sensor 554), devices, components, etc. in a drilling system. The AI interface circuit 532 and DI interface circuit 534 can be used to receive, interpret, and/or reformat sensor data and monitor the status of one or more components, such as by receiving analog signals and discrete signals, respectively, of the various sensors, devices, components, etc. in the drilling system.

The AO interface circuit 536 can include one or multiple outputs to output analog signals, which can be converted from digital data provided by the processor 510 and temporarily stored in the shared memory 530, for example. The DO interface circuit 538 can include one or multiple outputs and can output a discrete signal (e.g., on/off signal), which may be provided by the processor 510 and temporarily stored in the shared memory 530, for example. The AO interface circuit 536 and DO interface circuit 538 are communicatively coupled to the shared memory 530. The outputs of the AO interface circuit 536 and DO interface circuit 538 are communicatively coupled to inputs of various devices, components, etc., such as one or more analog input controllable components 556 and or more digital input controllable components 558, in a drilling system. The AO interface circuit 536 and DO interface circuit 538 can be used to control the operation of one or more components, such as by providing analog signals and discrete signals, respectively, to the various devices, components, etc. in the drilling system.

The second processing system 500 may also comprise a mass storage device 539 for storing machine-readable instructions and data. The mass storage device 539 may be connected to the processor 510, such as via the bus 522. The mass storage device 539 may be or comprise a tangible, non-transitory storage medium, such as a floppy disk drive, a hard disk drive, a CD drive, and/or DVD drive, among other examples. The program code instructions 540 may be stored in the mass storage device 539, the volatile memory 516, the non-volatile memory 518, the local memory 512, a removable storage medium, such as a CD or DVD, and/or another storage medium.

The modules and/or other components of the second processing system 500 may be implemented in accordance with hardware (such as in one or more integrated circuit chips, such as an ASIC), or may be implemented as software or firmware for execution by a processor. In the case of firmware or software, the implementation can be provided as a computer program product including a computer readable medium or storage structure containing computer program code (i.e., software or firmware) for execution by the processor.

In view of the entirety of the present disclosure, including the figures and the claims, a person having ordinary skill in the art will readily recognize that the present disclosure introduces an apparatus comprising a communications network that includes one or more processing systems and a common data bus, wherein: each of the one or more processing systems comprises a processor and a memory including computer program code; at least one of the one or more processing systems is configured to implement subsystem virtual networks in the communications network; each of the subsystem virtual networks is operable to communicatively couple together equipment controllers of equipment of a respective control subsystem of a well construction system; at least one of the one or more processing systems is operable to implement a configuration manager that is operable to translate communications from the subsystem virtual networks to a common protocol and to make data of the communications accessible through the common data bus; at least some of the equipment controllers being operable to access data from the common data bus through respective subsystem virtual networks; at least one of the one or more processing systems is operable to implement a process application that is operable to access data from the common data bus; at least one of the one or more processing systems is operable to implement a human-machine interface that is operable to access data from the common data bus; and at least one of the one or more processing systems is operable to implement a coordinated controller that is operable to issue a command to one or more of the equipment controllers.

Each of the subsystem virtual networks may be operable to implement an Ethernet-based communication protocol to communicate with the equipment controllers of the respective control subsystem. The Ethernet-based communication protocol may include one or more selected from the group consisting of ProfiNET, OPC, OPC/UA, Modbus TCP/IP, EtherCAT, UDP multicast, and Siemens S7 communication.

Each of the subsystem virtual networks may be operable to implement publish-subscribe communication to communicate with the equipment controllers of the respective control subsystem.

The data accessible from the common data bus may include sensor data, status data, or a combination thereof.

At least one of the equipment controllers of the respective control subsystem may be operable to issue a command to another of the equipment controllers of the respective control subsystem through the respective subsystem virtual network.

The coordinated controller may be operable to selectively prohibit or permit an equipment controller of a control subsystem from issuing a command to an equipment controller of a different control subsystem without the coordinated controller processing the command.

The coordinated controller may be operable to monitor one or more operations of the control subsystems and to issue a command to one or more equipment controllers of one or more of the control subsystems in response to the monitoring.

Equipment of a sensor subsystem may be communicatively coupled to the configuration manager without an intervening virtual network, and the configuration manager may be operable to translate communications from the equipment of the sensor subsystem to the common protocol and to make data of the communications accessible through the common data bus.

The coordinated controller may be operable to receive an input from the human-machine interface and to issue a command to one or more of the equipment controllers based on the input.

The coordinated controller may be operable to selectively prohibit or permit the human-machine interface from issuing a command to at least one of the equipment controllers without the coordinated controller processing the command.

At least one of the one or more processing systems may be operable to maintain a historian in memory, and the historian may be operable to access data from the common data bus and store the data accessible from the common data bus.

Each of the control subsystems may be selected from the group consisting of a drilling rig control system, a drilling fluid circulation system, a managed pressure drilling system, a cementing system, and a rig walk system.

The present disclosure also introduces an apparatus comprising: (A) a drilling system comprising a first control subsystem useable in making a wellbore in a formation, wherein the first control subsystem includes one or more first equipment controllers (ECs) operable to control a first operation of the first control subsystem, to receive a signal of a first sensor of the first control subsystem, or a combination thereof; and (B) a communications network comprising one or more processing systems and a common data bus, wherein: (i) each of the one or more processing systems comprises a processor and a memory including computer program code; (ii) at least one of the one or more processing systems is configured to implement a first subsystem virtual network in the communications network; (iii) the first subsystem virtual network is communicatively coupled to the one or more first ECs; (iv) at least one of the one or more processing systems is operable to implement a configuration manager that is operable to translate communications from the first subsystem virtual network to a common protocol and to make data of the communications accessible through the common data bus; (v) at least one of the one or more processing systems is operable to implement a process application that is operable to access data from the common data bus; (vi) at least one of the one or more processing systems is operable to implement a human-machine interface that is operable to access data from the common data bus; and (vii) at least one of the one or more processing systems is operable to implement a coordinated controller that is operable to issue a command to at least one of the one or more first ECs.

The first control subsystem may be selected from the group consisting of a drilling rig control system, a drilling fluid circulation system, a managed pressure drilling system, a cementing system, and a rig walk system.

The drilling system may further comprise a second control subsystem useable in making the wellbore in the formation. The second control subsystem may include one or more second ECs operable to control a second operation of the second control subsystem, to receive a signal of a second sensor of the second control subsystem, or a combination thereof. The first control subsystem may be a different type of system from the second control subsystem. At least one of the one or more processing systems may be configured to implement a second subsystem virtual network in the communications network. The second subsystem virtual network may be communicatively coupled to the one or more second ECs. The configuration manager may be operable to translate communications from the second subsystem virtual network to the common protocol and to make data of the communications accessible through the common data bus. The coordinated controller may be operable to issue a command to at least one of the one or more second ECs. At least some of the one or more first ECs and the one or more second ECs may be configured to access data from the common data bus through the first subsystem virtual network and the second subsystem virtual network, respectively. At least one of the one or more first ECs and the one or more second ECs may be operable to generate the command to be issued through the coordinated controller to at least one of the one or more first ECs and the one or more second ECs in a different control subsystem than where the command was generated. The coordinated controller may be operable to selectively prohibit or permit the command to be issued.

The one or more first ECs may include at least two ECs, and at least one of the at least two ECs may be operable to issue a command to another of the at least two ECs through the first subsystem virtual network.

The data accessible from the common data bus may include sensor data, status data, or a combination thereof.

The coordinated controller may be operable to monitor one or more operations of the first control subsystem and to issue the command to at least one of the one or more first ECs in response to the monitoring.

The human-machine interface may be operable to generate the command to be issued through the coordinated controller. In such implementations, among others within the scope of the present disclosure, the coordinated controller may be operable to selectively prohibit or permit the command to be issued.

The drilling system may further comprise a sensor subsystem including one or more communication devices operable to receive a signal of a second sensor of the sensor subsystem, the one or more communication devices may be communicatively coupled to the configuration manager without an intervening virtual network, and the configuration manager may be operable to translate communications from the one or more communication devices to the common protocol and to make data of the communications accessible through the common data bus.

At least one of the one or more processing systems may be operable to maintain a historian in memory, and the historian may be operable to access data from the common data bus and store the data accessible from the common data bus.

The present disclosure also introduces a method comprising operating a communications network including one or more processing systems and a common data bus, wherein operating the communications network comprises: (A) implementing subsystem virtual networks using at least one of the one or more processing systems, wherein via each of the subsystem virtual networks, equipment controllers of equipment a respective control subsystem of a drilling system are coupled together; (B) operating a configuration manager using at least one of the one or more processing systems, wherein operating the configuration manager comprises: (i) translating communications from the subsystem virtual networks to a common protocol; and (ii) providing data of the translated communications to the common data bus, wherein the data includes sensor data, status data, of a combination thereof; (C) operating a process application using at least one of the one or more processing systems, wherein operating the process application comprises accessing data from the common data bus; (D) operating a human-machine interface using at least one of the one or more processing systems, wherein operating the human-machine interface comprises accessing data from the common data bus; and (E) operating a coordinated controller using at least one of the one or more processing systems, wherein operating the coordinated controller comprises issuing a command to at least one of the equipment controllers of the control subsystems.

Each of the subsystem virtual networks may implement an Ethernet-based communication protocol to communicate with the equipment controllers of the respective control subsystem. The Ethernet-based communication protocol may include one or more selected from the group consisting of ProfiNET, OPC, OPC/UA, Modbus TCP/IP, EtherCAT, UDP multicast, and Siemens S7 communication.

Each of the subsystem virtual networks may implement publish-subscribe communication to communicate with the equipment controllers of the respective control subsystem.

At least one of the equipment controllers of the respective control subsystem may be operable to issue a command to another at least one of the equipment controllers of the respective control subsystem through the respective subsystem virtual networks.

At least one of the equipment controllers of the respective control subsystem may be operable to communicate sensor data, status data, of a combination thereof to another at least one of the equipment controllers of the respective control subsystem through the respective subsystem virtual networks.

Operating the configuration manager may further comprise providing data that is available on the common data bus to the subsystem virtual networks.

Operating the coordinated controller may further comprise receiving the command from at least one of the equipment controllers via the respective subsystem virtual network, wherein the command may be issued to the at least one of the equipment controllers of a different one or more of the control subsystems. In such implementations, among others within the scope of the present disclosure, operating the coordinated controller may further comprise determining whether to permit or prohibit the command to be issued, wherein the command may be issued when permitted.

Operating the coordinated controller may further comprise monitoring one or more operations of the control subsystems, wherein the command may be issued in response to the monitoring.

Operating the human-machine interface may comprise generating the command in response to user input, and operating the coordinated controller may comprise receiving the command from the human-machine interface, wherein the command may be issued. In such implementations, among others within the scope of the present disclosure, operating the coordinated controller may further comprise determining whether to permit or prohibit the command to be issued, wherein the command may be issued when permitted.

Operating the configuration manager may further comprise: translating sensor communications transmitted from a sensor subsystem without an intervening subsystem virtual network to the common protocol; and providing data of the translated sensor communications to the common data bus.

Operating the communications network may further comprise maintaining a historian in memory using at least one of the one or more processing systems, and the historian may store data accessible from the common data bus.

Each of the control subsystems may be selected from the group consisting of a drilling rig control system, a drilling fluid circulation system, a managed pressure drilling system, a cementing system, and a rig walk system.

The present disclosure also introduces a method comprising: (A) operating a first drilling subsystem comprising controlling a first component of the first drilling subsystem with a first equipment controller (EC); (B) implementing a first virtual network communicatively coupled to the first EC; (C) operating a configuration manager on one or more processing systems, wherein operating the configuration manager comprises: (i) translating first communications from the first virtual network to a common protocol; and (ii) providing data of the translated first communications to a common data bus, wherein the data includes sensor data, status data, of a combination thereof; (D) operating a process application on one or more processing systems, wherein operating the process application comprises accessing data from the common data bus; (E) operating a human-machine interface on one or more processing systems, wherein operating the human-machine interface comprises accessing data from the common data bus; and (F) operating a coordinated controller on one or more processing systems, wherein operating the coordinated controller comprises issuing a command to the first EC to alter an operation of the first component.

Operating the first drilling subsystem may comprise controlling a second component of the first drilling subsystem with a second EC, the first virtual network may be communicatively coupled to the second EC, and the first EC and the second EC may be operable to communicate a command, sensor data, status data, or a combination thereof between each other through the first virtual network without intervention of the coordinated controller.

The method may further comprise: operating a second drilling subsystem comprising controlling a second component of the second drilling subsystem with a second EC; and implementing a second virtual network communicatively coupled to the second EC. In such implementations, among others within the scope of the present disclosure, operating the configuration manager may comprise translating second communications from the second subsystem virtual network to the common protocol, and providing data of the translated second communications to the common data bus. Operating the coordinated controller may comprise receiving the command from the second virtual network. Operating the coordinated controller may comprise determining whether to permit or prohibit the command to be issued, wherein the command may be issued when permitted. Operating the configuration manager may further comprise providing data that is available on the common data bus to the first virtual network and the second virtual network.

Operating the coordinated controller may further comprise monitoring an operation of the first drilling subsystem, wherein the command may be issued in response to the monitoring.

Operating the human-machine interface may comprise generating the command in response to user input, and operating the coordinated controller may comprise receiving the command from the human-machine interface, wherein the command may be issued. In such implementations, among others within the scope of the present disclosure, operating the coordinated controller may further comprise determining whether to permit or prohibit the command to be issued, wherein the command may be issued when permitted.

Operating the configuration manager may further comprise: translating sensor communications transmitted from a sensor subsystem without an intervening subsystem virtual network to the common protocol; and providing data of the translated sensor communications to the common data bus.

The method may further comprise maintaining a historian in memory using at least one of the one or more processing systems, and the historian may store data accessible from the common data bus.

The first drilling subsystem may be selected from the group consisting of a drilling rig control system, a drilling fluid circulation system, a managed pressure drilling system, a cementing system, and a rig walk system.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72(b) to permit the reader to quickly ascertain the nature of the technical disclosure. It is submitted with the understanding that it will not be used to interpret or limit the scope or meaning of the claims.

What is claimed is:

1. A method comprising:
operating a first drilling subsystem comprising controlling a first component of the first drilling subsystem with a first equipment controller (EC);
implementing a first virtual network communicatively coupled to the first EC;
operating a configuration manager on one or more processing systems, wherein operating the configuration manager comprises:
translating first communications from the first virtual network to a common protocol; and
providing data of the translated first communications to a common data bus, wherein the data includes sensor data, status data, of a combination thereof;
operating a process application on one or more processing systems, wherein operating the process application comprises accessing data from the common data bus;
operating a human-machine interface on one or more processing systems, wherein operating the human-machine interface comprises accessing data from the common data bus; and
operating a coordinated controller on one or more processing systems, wherein operating the coordinated controller comprises issuing a command to the first EC to alter an operation of the first component.

2. The method of claim 1 wherein:
operating the first drilling subsystem comprises controlling a second component of the first drilling subsystem with a second EC;
the first virtual network is communicatively coupled to the second EC; and
the first EC and the second EC are operable to communicate a command, sensor data, status data, or a combination thereof between each other through the first virtual network without intervention of the coordinated controller.

3. The method of claim 1 further comprising:
operating a second drilling subsystem comprising controlling a second component of the second drilling subsystem with a second EC; and
implementing a second virtual network communicatively coupled to the second EC;
wherein operating the configuration manager comprises:
translating second communications from the second subsystem virtual network to the common protocol; and
providing data of the translated second communications to the common data bus.

4. The method of claim 3 wherein operating the coordinated controller comprises receiving the command from the second virtual network.

5. The method of claim 4 wherein operating the coordinated controller comprises determining whether to permit or prohibit the command to be issued, and wherein the command is issued when permitted.

6. The method of claim 3 wherein operating the configuration manager further comprises providing data that is available on the common data bus to the first virtual network and the second virtual network.

7. The method of claim 1 wherein operating the coordinated controller further comprises monitoring an operation of the first drilling subsystem, and wherein the command is issued in response to the monitoring.

8. The method of claim 1 wherein:
operating the human-machine interface comprises generating the command in response to user input; and
operating the coordinated controller comprises receiving the command from the human-machine interface, wherein the command is issued.

9. The method of claim 8 wherein operating the coordinated controller further comprises determining whether to permit or prohibit the command to be issued, and wherein the command is issued when permitted.

10. The method of claim 1 wherein operating the configuration manager further comprises:
translating sensor communications transmitted from a sensor subsystem without an intervening subsystem virtual network to the common protocol; and
providing data of the translated sensor communications to the common data bus.

11. The method of claim 1 further comprising maintaining a historian in memory using at least one of the one or more processing systems, wherein the historian stores data accessible from the common data bus.

12. The method of claim 1 wherein the first drilling subsystem is selected from the group consisting of a drilling rig control system, a drilling fluid circulation system, a managed pressure drilling system, a cementing system, and a rig walk system.

13. An apparatus comprising:
a communications network including one or more processing systems and a common data bus, wherein:
each of the one or more processing systems comprises a processor and a memory including computer program code;
at least one of the one or more processing systems is configured to implement subsystem virtual networks in the communications network;
each of the subsystem virtual networks is operable to communicatively couple together equipment controllers of equipment of a respective control subsystem of a well construction system;
at least one of the one or more processing systems is operable to implement a configuration manager that is operable to translate communications from the subsystem virtual networks to a common protocol and to make data of the communications accessible through the common data bus;
at least some of the equipment controllers are operable to access data from the common data bus through respective subsystem virtual networks;
at least one of the one or more processing systems is operable to implement a process application that is operable to access data from the common data bus;
at least one of the one or more processing systems is operable to implement a human-machine interface that is operable to access data from the common data bus; and
at least one of the one or more processing systems is operable to implement a coordinated controller that is operable to issue a command to one or more of the equipment controllers.

14. The apparatus of claim 13 wherein each of the subsystem virtual networks is operable to implement an Ethernet-based communication protocol and/or publish-subscribe communication to communicate with the equipment controllers of the respective control subsystem.

15. The apparatus of claim 13 wherein at least one of the equipment controllers of the respective control subsystem is operable to issue a command to another of the equipment controllers of the respective control subsystem through the respective subsystem virtual network.

16. The apparatus of claim 13 wherein:
equipment of a sensor subsystem is communicatively coupled to the configuration manager without an intervening virtual network; and
the configuration manager is operable to translate communications from the equipment of the sensor subsystem to the common protocol and to make data of the communications accessible through the common data bus.

17. The apparatus of claim 13 wherein the coordinated controller is operable to selectively prohibit or permit an equipment controller of a control subsystem from issuing a command to an equipment controller of a different control subsystem without the coordinated controller processing the command.

18. The apparatus of claim 13 wherein the coordinated controller is operable to:
receive an input from the human-machine interface and issue a command to one or more of the equipment controllers based on the input; and
selectively prohibit or permit the human-machine interface from issuing a command to at least one of the equipment controllers without the coordinated controller processing the command.

19. The apparatus of claim 13 wherein at least one of the one or more processing systems is operable to maintain a historian in memory, and wherein the historian is operable to access data from the common data bus and store the data accessible from the common data bus.

20. A method comprising:
operating a communications network including one or more processing systems and a common data bus, wherein operating the communications network comprises:
implementing subsystem virtual networks using at least one of the one or more processing systems, wherein via each of the subsystem virtual networks, equipment controllers of equipment a respective control subsystem of a drilling system are coupled together;
operating a configuration manager using at least one of the one or more processing systems, wherein operating the configuration manager comprises:
translating communications from the subsystem virtual networks to a common protocol; and
providing data of the translated communications to the common data bus, wherein the data includes sensor data, status data, of a combination thereof;
operating a process application using at least one of the one or more processing systems, wherein operating the process application comprises accessing data from the common data bus;
operating a human-machine interface using at least one of the one or more processing systems, wherein operating the human-machine interface comprises accessing data from the common data bus; and
operating a coordinated controller using at least one of the one or more processing systems, wherein operating the coordinated controller comprises issuing a command to at least one of the equipment controllers of the control subsystems.
